(19) United States
(12) Patent Application Publication
(10) Pub. No.: US 2011/0097450 A1
(43) Pub. Date: Apr. 28, 2011

(54) PORTION CAPSULE AND METHOD FOR PRODUCING A PORTION CAPSULE

(75) Inventor: Marc KRÜGER, Bergisch-Gladbach (DE)

(73) Assignee: KRUGER GMBH & CO. KG, Bergisch-Gladbach (DE)

(21) Appl. No.: 12/909,998

(22) Filed: Oct. 22, 2010

(30) Foreign Application Priority Data
Oct. 23, 2009 (DE) 10 2009 050 537.7

(51) Int. Cl. B65D 85/816; A23F 5/00

(52) U.S. Cl. 426/77; 426/394

(57) ABSTRACT

A portion capsule for producing a beverage is proposed, having a substantially frustoconical or cylindrical base element which has a cavity, and having a membrane which closes off the cavity, with a filter element being arranged within the cavity, the filter element dividing the cavity into a first region for holding a beverage raw material and into a second region for receiving a beverage extract, wherein the filter element is fastened to the base element by means of at least one ultrasonic welded joint.

### BACKGROUND

The present invention relates to a portion capsule for producing a beverage, having a substantially frustoconical or cylindrical base element which has a cavity, and having a membrane which closes off the cavity, with a filter element being arranged within the cavity, the filter element dividing the cavity into a first region for holding a beverage raw material and into a second region for holding a beverage extract.

Such portion capsules are generally known. For example, the document FR 2 556 323 A1 discloses a portion capsule which has a frustoconical or cylindrical base element and is used for producing a beverage, with the first region of the cavity within the portion capsule being filled with the beverage raw material, in particular with a coffee powder. To produce a coffee beverage, the portion capsule is arranged in a brewing chamber in which the membrane is perforated and an extraction liquid, in particular hot water, is introduced into the first region. The extraction liquid flows through the beverage raw material, so as to form a beverage extract, in particular a coffee beverage, which passes through the filter element into the second region of the cavity. By means of the sieve function of the filter element, the beverage raw material is prevented from passing into the second region. In the brewing chamber, a bottom region of the portion capsule is also perforated such that the beverage extract can leave the portion capsule and pass, if appropriate, into a beverage receptacle, such as, for example, a coffee cup.

A disadvantage of said portion capsule is that the filter element is not fixedly connected to the base element, and a relative movement between the filter element and the base element is therefore possible. Therefore, in particular during the transportation and storage of the portion capsules, the possibility of the filter element slipping out of place cannot be ruled out. Furthermore, modern coffee extraction machines operate at relatively high pressures, as a result of which there is the risk of the filter element in the portion capsule being washed upwards or floating upwards during the injection of the extraction liquid into the first region. Such displacements of the filter element could lead to the beverage raw material passing around the filter element from the first region into the second region. During production of the beverage, said beverage raw material is subsequently conducted into the beverage receptacle, thereby impairing the quality of the beverage. In the case of coffee powder, for example, being used as a beverage raw material, this results in an undesired bitter taste of the coffee beverage, and residues of the coffee raw material are found in the beverage receptacle.

It is therefore the object of the present invention to fasten the filter element so as to effectively prevent a relative movement between the base element and the portion capsule. In this way, the beverage raw material is prevented from passing from the first region into the second region and impairing the taste and appearance of the beverage to be produced.

### SUMMARY

The object is achieved by means of a portion capsule for producing a beverage, having a substantially frustoconical or cylindrical base element which has a cavity and a membrane which closes off the cavity, with a filter element being arranged within the cavity, the filter element dividing the cavity into a first region for holding a beverage raw material and into a second region for holding a beverage extract, wherein the filter element is fastened to the base element by means of at least one ultrasonic welded joint.

The portion capsule according to the invention has the advantage over the portion capsule according to the prior art that the filter element is fixedly connected to the base element. Firstly, therefore, the portion capsule is considerably less susceptible to being shaken and to the action of external force, for example during storage or transportation, and, secondly, extraction under considerably higher pressures is made possible. The risk of the beverage which is produced from the portion capsule being contaminated with beverage raw material is reduced, and an improvement is therefore obtained in the quality of the beverage produced. Furthermore, the ultrasonic welded joint can be produced comparatively cost-effectively and simply. In particular, the filter element can be fastened retrospectively to standard base elements. The beverage raw material comprises, in particular, coffee powder (preferably roast coffee), chocolate powder, milk powder or the like. As an alternative, it is conceivable for the beverage raw material to comprise a beverage extract, such as, for example, instant coffee.

Advantageous refinements and developments of the invention emerge from the dependent claims and from the description with reference to the drawings.

According to a preferred development, the filter element is connected to a portion capsule wall and/or to a portion capsule bottom by means of the ultrasonic welded joint. The filter element is advantageously therefore fixed in the base element without the base element having to be precisely matched to the filter element. The demands imposed on the production tolerances are therefore comparatively low.

According to a further subject matter or a preferred development of the present invention, the filter element has a border region, with passage openings being formed in the border region. Therefore, the filter element is advantageously significantly more permeable for the extraction liquid than in the prior art.

According to a preferred development, the passage openings are each of slot-shaped design. A slot-shaped design of the passage openings has the advantage of promoting the formation of crema during the extraction of a beverage substance consisting of roast coffee.

According to a preferred development, the filter element is of frustoconical design, the filter element having a bottom region substantially parallel to the membrane, and the border region comprising a wall region which encircles the bottom region, with filter openings being formed in the bottom region. It is therefore preferably made possible for the filter element to have a maximum degree of permeability for the extraction liquid or the beverage extract, with the filtration action of the filter element at the same time not being impaired.

According to a preferred development, the passage openings which are of slot-shaped design extend substantially perpendicularly to the circumferential direction of the border region and/or at least partially extend from the bottom region in the direction of the portion capsule bottom such that advantageously as large a number as possible of passage openings of slot-shaped design can be formed in the border region.

According to a preferred development, the sum of the cross sections of the filter openings comprises at least 30 percent, preferably at least 50 percent, particularly preferably at least 75 percent and very particularly preferably at least 80 percent of the total surface of the bottom region. Therefore, the flow resistance of the filter element for the extraction liquid or for the beverage extract is advantageously minimized.

A further subject matter of the present invention is a method for producing a portion capsule, wherein, in a first step, the base element is provided, wherein, in a second step, the filter element is arranged in the base element, and wherein, in a third step, the filter element is connected to the base element, with an ultrasonic welding process being used in a third step. Preferably, in a fourth step, a beverage raw material is poured into the first region and, in a fifth step, the membrane is arranged on the base element. The production method according to the invention has the advantage that, firstly, a fixed and permanent connection is produced between the base element and the filter element and, secondly, special production costs are obtained, since ultrasonic welding processes can be realized in a comparatively cost-effective and simple manner.

Exemplary embodiments of the invention are illustrated in the figures and explained in more detail in the description below. The figures are described merely by way of example and do not restrict the general inventive concept.

### BRIEF DESCRIPTION OF THE FIGURES

FIGS. 1a, 1b and 1c show schematic, lateral sectional views of a portion capsule according to a first, second and third embodiment of the present invention.

FIGS. 2a and 2b show a schematic, lateral sectional view and a plan view of a portion capsule according to a fourth embodiment of the present invention.

FIG. 3 shows a schematic side view of a portion capsule according to a fifth embodiment of the present invention.

In the various figures, the same parts are always provided with the same reference numbers and are therefore generally also each specified or mentioned only once.

### DETAILED DESCRIPTION

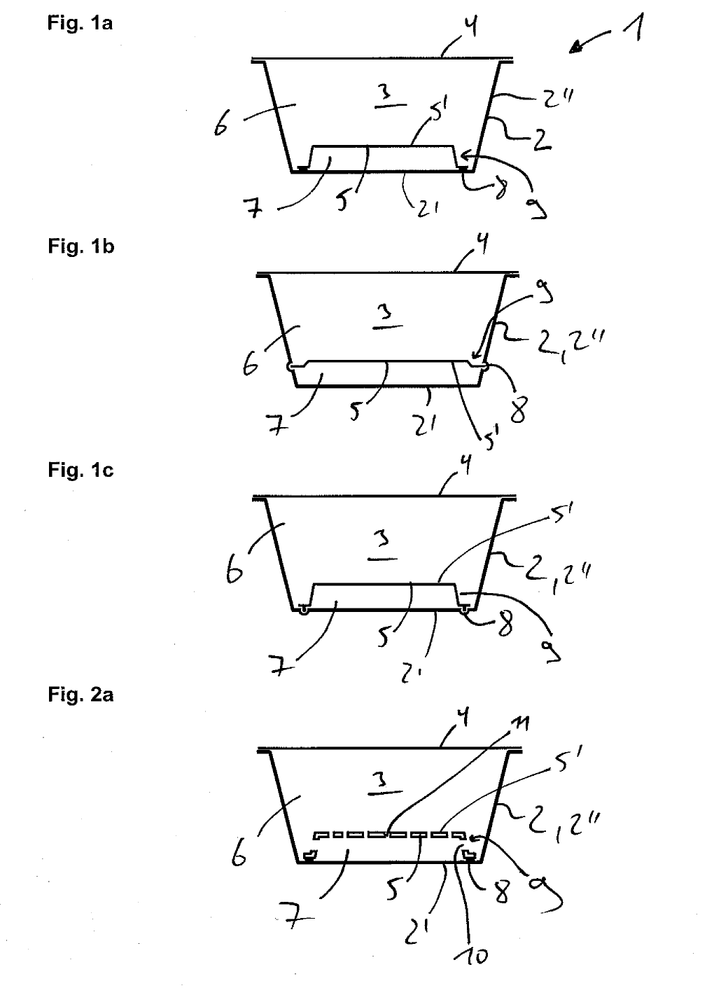

FIGS. 1a, 1b and 1c illustrate schematic, lateral sectional views of a portion capsule 1 according to a first, second and third embodiment of the present invention, wherein the portion capsule 1 has a substantially frustoconical base element 2 which is shaped in a manner similar to a cup and surrounds a cavity 3. The cavity 3 is closed off by a membrane 4. The base element 2 comprises in particular a soft or rigid plastics material. The membrane 4 preferably comprises a thin plastics film or aluminium foil. The base element 2 has an encircling fastening flange 20 in the region of the membrane 4, the membrane 4 being connected to the fastening flange 20 in a materially joined fashion, in particular by welding or adhesive bonding. A filter element 5 which is produced from a thermoplastic, for example polypropylene, is arranged within the base element 2. The filter element 5 divides the cavity 3 into a first region 6 and into a second region 7. The first region 6 is provided for holding a beverage raw material, which for clarity is not illustrated in the figures. For example, the first region 6 is filled with a coffee powder before the cavity 3 is closed off by the membrane 4. The coffee powder is preferably intensely compressed when poured into the first region 6. The second region 7 serves to hold and in particular to collect a beverage extract (not depicted) during the extraction process of the portion capsule 1. The portion capsule 1 is provided for insertion into the brewing chamber of a coffee machine (not shown) in which an extraction liquid (for example, hot water) is supplied, preferably under high pressure, to the first region 6. Said extraction liquid interacts with the beverage raw material so as to form a beverage extract. The filter element 5 has a plurality of filter openings 11 (not depicted) in a bottom region 5′ and therefore functions as a sieve for the beverage extract. The beverage extract therefore passes through the filter openings 5′ into the second region 7. The second region 7 is delimited by a portion capsule bottom 2′ of the base element 2, which is pierced in the brewing chamber, for example by a puncturing stem of the coffee machine, in order to produce an outlet opening for the beverage extract. It is alternatively conceivable for an outlet opening to be formed automatically in the portion capsule bottom 2′ under the pressure of the extraction liquid, and/or for an outlet opening or an outlet valve already to be implemented in the portion capsule bottom 2′. The cross section of the filter openings 11 is selected such that no particles of the beverage raw material pass from the first region 6 to the second region 7. To prevent the filter element 5 from being displaced relative to the base element 2, each portion capsule 1 has an ultrasonic welded joint 8 to connect it to the base element 2. In the first embodiment, which is illustrated in FIG. 1a, the filter element 5 is fastened to the portion capsule bottom 2′ via the ultrasonic welded joint 8. In the second embodiment, which is illustrated in FIG. 1b, the filter element 5 is fastened to a portion capsule wall 2″ via the ultrasonic welded joint 8. In the third embodiment, which is illustrated in FIG. 1c, the filter element 5 is fastened to the portion capsule bottom 2′ via the ultrasonic welded joint 8, with the filter element 5 additionally being pressed into and/or latched in grooves of the portion capsule bottom 2′. The filter element 5 is preferably connected to the portion capsule bottom 2′ in a manner modelled on a frictional press stud mechanism. Therefore, in all three embodiments, the filter element 5 is prevented from being displaced relative to the base element 2, for example during storage and during transportation or during the injection of the extraction liquid under high pressure into the first region 6. This removes the risk of particles of the beverage raw material passing into the second region 7 past the filter element 5.

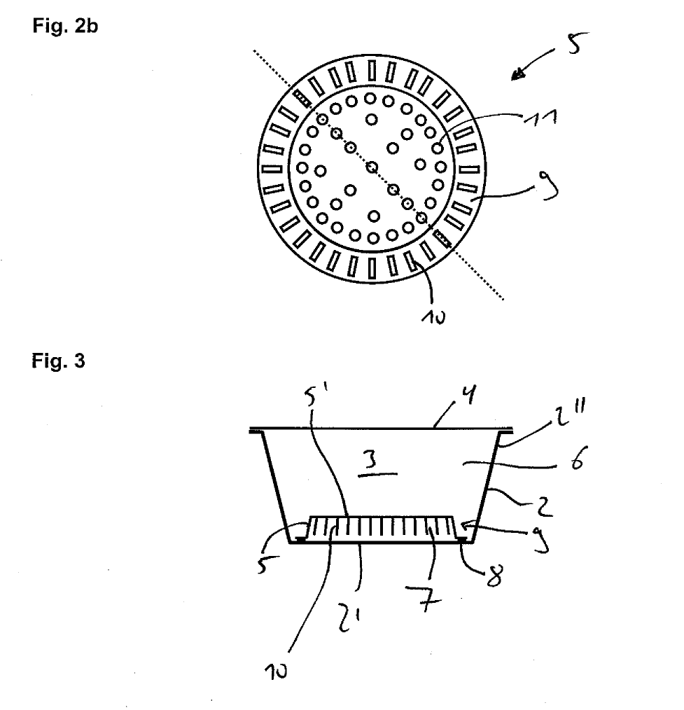

FIGS. 2 and 2b illustrate a schematic, lateral sectional view and plan view of a portion capsule 1 according to a fourth embodiment of the present invention, wherein the fourth embodiment is substantially equivalent to the first embodiment, which is illustrated in FIG. 1a, the filter element 5 having a border region 9 in which slot-shaped passage openings 10 extending substantially perpendicularly to the circumferential direction of the border region 9 are formed. The filter openings 11 which are distributed on the bottom region 5′ are also illustrated.

FIG. 3 illustrates a schematic side view of a portion capsule 1 according to a fifth embodiment of the present invention, wherein the fifth embodiment is substantially equivalent to the fourth embodiment, which is illustrated in FIG. 2a. In this case, the slot-shaped passage openings 10 extend partially from the bottom region 5′ in the direction of the portion capsule bottom 2′.

1. Portion capsule for producing a beverage, having a substantially frustoconical or cylindrical base element which has a cavity, and having a membrane which closes off the cavity, with a filter element being arranged within the cavity, the filter element dividing the cavity into a first region for holding a beverage raw material and into a second region for holding a beverage extract, characterized in that the filter element is fastened to the base element by means of at least one ultrasonic welded joint.

2. Portion capsule according to claim 1, characterized in that the filter element is connected to a portion capsule wall and/or to a portion capsule bottom by means of the ultrasonic welded joint.

3. Portion capsule according to claim 1, characterized in that the filter element has a border region, with passage openings being formed in the border region.

4. Portion capsule according to claim 3, characterized in that the passage openings are each of slot-shaped design.

5. Portion capsule according to claim 3, characterized in that the filter element is of frustoconical design, the filter element having a bottom region substantially parallel to the membrane, and the border region comprising a wall region which encircles the bottom region, with filter openings being formed in the bottom region.

6. Portion capsule according to claim 4, characterized in that the passage openings which are of slot-shaped design extend substantially perpendicularly to the circumferential direction of the border region and/or at least partially extend from the bottom region in the direction of the portion capsule bottom.

7. Portion capsule according to claim 1, characterized in that the sum of the cross sections of the filter openings comprises at least 30 percent of the total surface of the bottom region.

8. Method for producing a portion capsule according to claim 1, characterized in that, in a first step, the base element is provided, in that, in a second step, the filter element is arranged in the base element, and in that, in a third step, the filter element is connected to the base element, with an ultrasonic welding process being used in the third step.

9. Method according to claim 8, characterized in that, in a fourth step, a beverage raw material is poured into the first region, and in that, in a fifth step, the membrane is arranged on the base element.

10. Portion capsule according to claim 2, characterized in that the filter element has a border region, with passage openings being formed in the border region.

11. Portion capsule according to claim 4, characterized in that the filter element is of frustoconical design, the filter element having a bottom region substantially parallel to the membrane, and the border region comprising a wall region which encircles the bottom region, with filter openings being formed in the bottom region.

12. Portion capsule according to claim 11, characterized in that the passage openings which are of slot-shaped design extend substantially perpendicularly to the circumferential direction of the border region and/or at least partially extend from the bottom region in the direction of the portion capsule bottom.

13. Portion capsule according to claim 5, characterized in that the passage openings which are of slot-shaped design extend substantially perpendicularly to the circumferential direction of the border region and/or at least partially extend from the bottom region in the direction of the portion capsule bottom.

14. Portion capsule according to claim 1, characterized in that the sum of the cross sections of the filter openings comprises at least 50 percent of the total surface of the bottom region.

15. Portion capsule according to claim 1, characterized in that the sum of the cross sections of the filter openings comprises at least 75 percent of the total surface of the bottom region.

16. Portion capsule according to claim 1, characterized in that the sum of the cross sections of the filter openings comprises at least 80 percent of the total surface of the bottom region.

17. Portion capsule for producing a beverage, having a substantially frustoconical or cylindrical base element which has a cavity, and having a membrane which closes off the cavity, with a filter element being arranged within the cavity, the filter element dividing the cavity into a first region for holding a beverage raw material and into a second region for holding a beverage extract, characterized in that the filter element has a border region, with passage openings being formed in the border region.

18. Portion capsule according to claim 17, characterized in that the passage openings are each of slot-shaped design.
